(19) United States
(12) Patent Application Publication
(10) Pub. No.: US 2009/0246344 A1
(43) Pub. Date: Oct. 1, 2009

(54) Antioxidant Agent and Beverage Using Same

(75) Inventor: Yoshihiko Sasaki, Shizuoka (JP)

Correspondence Address: PETERS VERNY , L.L.P., 425 SHERMAN AVENUE, SUITE 230, PALO ALTO, CA, 94306, US

(73) Assignee: SASAKI TEA MANUFACTURING CO., LTD., Shizuoka (JP)

(21) Appl. No.: 12/059,126

(22) Filed: Mar. 31, 2008

(51) Int. Cl. C11B 5/00

(52) U.S. Cl. 426/542

(57) ABSTRACT

An antioxidant agent capable of easily enhancing the intake of ORAC (Oxygen Radical Absorbance Capacity) is proposed. The antioxidant agent includes tealeaf as an active ingredient for enhancing ORAC. The tealeaf is preferably plucked from tea Camellia sinensis, decaffeinated or in a powdery form having a median diameter equal to or less than 50 μm. A beverage using such antioxidant agent is also proposed.

### TECHNICAL FIELD

The present invention relates to an antioxidant agent, an in particular, relates to an antioxidant agent that is used for enhancing an antioxidant unit such as ORAC (Oxygen Radical Absorbance Capacity) and a beverage using the agent.

### RELATED ART

Changes of lifestyle habits or social environments have increased patients or potential patients who suffer from a so-called adult disease such as diabetes, dyslipidemia, high-blood pressure, cancer, obesity or the like. This phenomenon is said to be the most disincentive hindrances to health longevity in a modern society. Recently, it has been revealed that active oxygen is deeply involved in those adult diseases or in aging. Human beings take oxygen in bodies thereof by means of breathing to produce energy necessary for a daily life. However, it has been said that 1 to 2% of the intake oxygen becomes active oxygen. Active oxygen is a major weapon with which white blood cells or immune cells attack pathogens and viruses invading the body, and accordingly, is an extremely important substance within an organism. On the other hand, excessive intake of active oxygen could lead to harm for a human body. It has been known that active oxygen may be generated in a body due to excessive stress, smoking, electromagnetic waves or the like.

In a body, an antioxidant enzyme such as SOD (Superoxide Dismutase) enzyme is present which adjusts the amount of active oxygen to render the active oxygen harmless. However, an antioxidant enzyme decreases due to aging after peaking around the age of 25. In addition, it is necessary to protect a body from mass generation of active oxygen caused by excessive stress or the like. Therefore, it is important to fully supplement minerals (e.g., zinc, selenium, copper, or manganese) that facilitate an antioxidant function by transforming food to be daily ingested into antioxidant ingredients (ingredients which render active oxidant harmless) or into constituent elements of an antioxidant enzyme.

A large number of methods have been developed which measure antioxidant capacity of food. However, an official method for this measurement has not been developed yet. Additionally, these methods vary in types of foods to be measured, simplicity of measurement procedure and correlatively with actual antioxidant capacity in an organism. Oxygen Radical Absorbance Capacity (herein after referred to as “ORAC”), which is an index of antioxidant capacity developed by researchers in the USDA (United States Department of Agriculture) and the NIA (National Institute on Aging), is not quantified by measuring the amount of a specific antioxidant substance, but by converting strength of antioxidant capacity into values with respect to a vitamin E analogue (Trolox). This method has fewer problems than the above-mentioned conventional measuring methods. Accordingly, in the United States, food products labeled with ORAC values as a value indicative of its antioxidant capacity have been increasing and are expected to further expand.

### DISCLOSURE OF THE INVENTION

### Problems to be Solved by the Invention

Antioxidant ingredients are contained in fruits and/or vegetables among food. Therefore, an ingestion of many fruits and/or vegetables enables to enhance the ORAC value capable of being ingested on a daily basis. However, it may be difficult to procure fruits and vegetables depending on a time of the year or a location, and there is a case where sufficient fruits and vegetables may not be taken due to taste. Accordingly, it is required to more easily enhance an intake of ORAC.

Therefore, it is an object of the present invention to provide an antioxidant agent capable of easily enhancing the intake of ORAC and a beverage using such agent.

### Means for Solving the Problem

In order to achieve the above-mentioned object, the present invention is an antioxidant agent comprising tealeaf as an active ingredient for enhancing ORAC (Oxygen Radical Absorbance Capacity).

In this antioxidant agent, as tealeaf, it is preferable to use tealeaf plucked from Camellia sinensis, to use decaffeinated tealeaf, and to use powdered tealeaf having a median diameter equal to or less than 50 μm, respectively. It is noted that a median diameter as used herein means a particle diameter at which accumulated particle amount is 50%.

Moreover, the antioxidant agent preferable has an ORAC value equal to or more than 950 unit/g, is individually packed per a unit dosage, and has an ORAC value equal to or more than 5,300 units per one package, respectively.

Further, the antioxidant agent is suitable for use in a beverage.

In this beverage, it is preferred that fruit juice, vegetable juice or a mixture thereof is contained; a ratio of the ORAC value derived from tealeaf powder to the total ORAC value is equal to or more than 50%; the ORAC value is equal to or more than 7.4 unit/g and equal to or more than 1,767 unit/serving; and especially the ORAC value is equal to or more than 22.1 unit/g and equal to or more than 5,300 unit/serving, respectively.

### BEST MODE FOR CARRYING OUT THE INVENTION

Hereinafter, illustrative examples of the present invention will be discussed. However, a scope of the present invention shall not be restricted to these examples.

An antioxidant agent according to the present invention is characterized by comprising tealeaf as an active ingredient for enhancing ORAC (Oxygen Radical Absorbance Capacity). It should be noted that “ORAC” or “ORAC value” as used herein shall comply with a definition of the USDA (United States Department of Agriculture).

As an antioxidant ingredient, vitamins such as vitamin C, vitamin E, and vitamin A; polyphenols such as catechin, anthocyanin, and curcumin have been well known, all of which are contained in fruits and vegetables among food ingested on a daily basis. However, in a general eating habit, it is difficult to ingest adequate amounts of fruits and/or vegetables for achieving a sufficient ORAC value. Accordingly, the inventor reached an idea to use tealeaf as a more convenient supplement of the ORAC. Table 1 shows antioxidant capacity of typical fruits and vegetables, as well as green tea representative of tealeaf with using the ORAC values. From Table 1, it can be understood that green tea indicates the ORAC value as many as twenty to five hundred times or even more than those of the others, which reveals extremely high antioxidant capacity.

TABLE 1

| | ORAC^{a} |
|---|---|
| Product name | (μmol TE/g)^{b} |
| Green tea | 1,900 |
| Apple | 25.9 |
| Banana | 8.8 |
| Blueberry | 62.2 |
| Cranberry | 94.6 |
| Red grape | 12.6 |
| Spinach | 26.4 |
| Carrot | 12.2 |
| Tomato | 3.4 |
| Broccoli | 15.9 |
| Cabbage | 13.6 |

^{a}The value of the green tea is based on a result analyzed by the applicant. Other values are from J. Agric. Food Chem. 2004, 52, 4026-4037.
^{b}The unit of ORAC is indicated by a vitamin E analogue (Trolox) equivalent.

Next, Table 2 shows representative ingredients contained in tealeaf. Tealeaf contains 8-20% of catechins, which contributes to the antioxidant capacity most. Additionally, tealeaf contains various useful ingredients such as minerals which facilitate an antioxidant function; protein, lipid, carbohydrate, and vitamin all of which are the other five major nutrients; and further, fiber which has been said to be similarly effective for preventing an adult disease and called as the sixth nutrient. Regarding tea, a method has been general so far where an exudates fluid thereof is used. However, its useful ingredients remain even in tea dregs in a state where the useful ingredients have not been sufficiently extracted, or a number of insoluble ingredients, which hardly seep into even in hot water, are also contained in tea. Therefore, it is useful to use tealeaf as it is in order to make the best use of the useful ingredients. Moreover, it can be also said that it is useful, because tea dregs, which will normally become wastes, are not produced.

TABLE 2

| Soluble ingredients | Insoluble ingredients |
|---|---|
| Catechins | Lipophilic vitamin |
| Epigallocatechin gallate, Epicatechin gallate, | Vitamin A, Vitamin E, |
| Epigallocatechin, etc. | Vitamin D, etc. |
| Caffeine | Insoluble fiber |
| Mineral | Protein |
| Potassium, Magnesium, Zinc, Manganese, | |
| etc. | |
| Soluble vitamin | Fat |
| Vitamins Cs, Vitamins Bs, Folate, etc. | |
| Amino acid | Chlorophylls |
| Theanine, Glutamic acid, Arginine, etc. | |
| Soluble fiber | |
| Saponin | |
| Organic acid | |
| Oxalic acid, Quinic acid, etc. | |
| Sugars | |

Accordingly, when tealeaf is used as an active ingredient for composing the antioxidant agent, the ORAC can be effectively enhanced even with a comparatively smaller amount of the antioxidant agent. Furthermore, tealeaf has been used as a food for a long period of time, so that it can be said that tealeaf reveals excellent safety and an advantage in terms of costs.

It is possible to suitably add to the antioxidant agent according to the present invention a sweetener, an acidulant, a seasoning, a pH adjuster, an antioxidant, an emulsifier, a firming agent, a color, a fragrance, a glazing agent, a lubricating agent, an excipient, a stabilizer, a preservative, sugars, and other food materials, as well as tealeaf. The antioxidant agent may be formed in a pill, powder, granular, liquid form or the like according to its application.

Tealeaf used in the present invention may be one obtained through a fabrication of leaf plucked from tea whose scientific name is “Camellia sinensis”, and to be more precise, is green teas (unfermented tea) such as broiled tea, jade dew, roasted green tea, ground tea; oolong teas (semi-fermented tea) such as Tie Guan Yin tea, blue tea; black teas (fermented tea) such as Darjeeling, Assam, Uva; or the like. It is possible to use these leaves in a single or a mixed manner.

Tealeaf contains 2-4% of caffeine. Therefore, when the amount of tealeaf to be used is increased in order to raise the ORAC value, the amount of ingested caffeine which is contained in the tealeaf will be also increased. Caffeine has been known to cause, on one hand, beneficial effects such as an awakening effect, an elevating effect of a muscle and/or fatigue resistance, and a tranquilization effect, because of a central stimulation effect of caffeine. On the other hand, caffeine has also been known to cause an adverse effect such as insomnia or an excessive excitatory effect for an elderly adult, whose metabolic function is getting lower, for a infant whose metabolic function has not been developed yet, or for those who are intolerant to a stimulatory substance. Further, an effect on a fetus has also been concerned, in a case where a pregnant woman excessively ingests caffeine. In addition, because caffeine is one of bittering components contained in tea, tealeaf prepared by removing caffeine is preferably used in order to provide the useful components for more people.

In order to selectively remove caffeine while at the same time leaving the useful components contained in tealeaf, a method has been generally employing a varietal improvement, an organic solvent extraction (chemical method), a water extraction (water method), or a supercritical extraction (supercritical carbon dioxide extraction). Any of these methods can be employed. However, the method employing the varietal improvement has a difficulty in a stable supply. The method employing the organic solvent extraction has a problem in safety. With regard to the method employing the water extraction, because a caffeine-removal ratio is comparatively lower and other useful components are prone to decrease, it is further preferable to use tealeaf decaffeinated by means of the super critical extraction and especially tealeaf decaffeinated until the caffeine content becomes equal to or less than 0.5%.

When the antioxidant agent according to the present invention is mixed in a liquid such as water, the tealeaf is preferably powdered to have a median radius of equal to or less than 50 μm, in terms of dispersibility into water and of a stability in the liquid after being dispersed.

In addition, it is preferable to obtain a higher ORAC value through a comparative smaller amount of usage. From this point of view, the antioxidant agent according to the present invention preferably has the ORAC value of equal to or more than 950 unit/g.

Table 3 shows the result where the amount of antioxidant components to be desirably ingested in a day was calculated as the ORAC value by use of a recommended daily ingestion of fruits and vegetables on the basis of documents issued by the Japanese Ministry of Health, Labor, and Welfare and from the United States. Based on this result and taking into consideration that humans come under the influence of food other than fruits and vegetables, it would be desirable to ingest the antioxidant components having equal to or more than 5,300 ORAC.

TABLE 3

| | | | Recommended |
|---|---|---|---|
| | Recommended | ORAC average | daily ingestion of |
| | daily ingestion^{a} | value^{b} (μmol of | ORAC (μmol of |
| Item name | (g/day) | TE/g) | TE/day) |
| Fruits | 150 | 15.9 | 2,385 |
| Green and yellow | 120 | 11.9 | 1,428 |
| vegetables | | | |
| Other vegetables | 230 | 6.2 | 1,426 |
| Total | — | — | 5,239 |

^{a}The values are compiled from “Recommended Dietary Allowances for Japanese - Utilization of food ingestion reference”, sixth revision, issued by the Japanese Ministry of Health, labor, and, Welfare, on March. 2000”.
^{b}The average value of the corresponding items in Table 4 was used.

Table 4 shows the ORAC values of fruits and vegetables used in calculating the above-mentioned ORAC values.

TABLE 4

| Type | Item name^{a} | ORAC^{b} (μmol of TE/g) |
|---|---|---|
| Fruits | Strawberry | 35.8 |
| | Citruses | 16.8 |
| | Banana | 8.8 |
| | Apple | 25.9 |
| | Other raw fruits | 21.8^{c} |
| | Jam | 1.0^{d} |
| | Fruit juice/Fruit juice | 1.0^{d} |
| | beverage | |
| Green and yellow | Tomato | 3.4 |
| vegetables | Carrot | 12.2 |
| | Spinach | 26.4 |
| | Green pepper | 5.6 |
| | Other green and yellow | 11.9^{e} |
| | vegetables | |
| Other vegetables | Cabbage | 13.6 |
| | Cucumber | 1.2 |
| | Radish | 9.5 |
| | Onion | 10.3 |
| | Chinese cabbage | 1.0^{d} |
| | Other light-colored | 7.1^{f} |
| | vegetables | |
| | Vegetable juice | 5.6 |
| | Pickle | 1.0^{d} |

^{a}The values are compiled from “Ingestion amount of nutrition categorized by food group in a national health and nutrition examination survey in 2004” issued by the Japanese Ministry of Health, labor, and Welfare.
^{b}The values are compiled from “J. Agric. Food Chem. 2004, 52, 4026-4037”.
^{c}The value is calculated by averaging the values of strawberry, citruses, banana, and apple.
^{d}Because any data are not available, the number of “1.0” is used for a descriptive purpose.
^{e}The value is calculated by averaging the values of tomato, carrot, spinach, and green pepper.
^{f}The value is calculated by averaging the values of cabbage, cucumber, radish, onion, and Chinese cabbage.

Therefore, when the antioxidant agent according to the present invention is used in a dietary supplement application, the antioxidant agent is preferably individually packed per a unit dosage, and the ORAC value per one package is equal to or more than 5,300 units.

Additionally, the antioxidant agent according to the present invention can also be compounded into a beverage. The beverage attracts wide spread popularity as a thirst-quench beverage, which replenishes lost water, or as a preference beverage, and is one of representatives among foods. A beverage is essential to daily meals, a rest time or the like, and can be said to be much suitable for easily ingesting the antioxidant components. Tealeaf powder has an extremely strong antioxidant capacity even in a small amount, so that it can easily enhance antioxidant capacity of a beverage when added to the beverage.

In a case where a particle size of tealeaf powder to be added is large, it is likely to impair the quality of a beverage due to precipitation or to become difficult to drink due to a rough surface in a mouth. Therefore, its median radius is preferably equal to or less than 50 μm, and more preferably equal to or less than 20 μm.

In addition, the beverage to which tealeaf powder is added preferably contains juice squeezed from fruits and/or vegetables, as well as a mixture thereof to alleviate bitterness of tea or precipitation of tealeaf powder and to promote an image of well-being of the overall product. Each of fruits and/or vegetables contains the antioxidant ingredient also in itself, and an addition of fruits and/or vegetables also leads to an enhancement of the antioxidant capacity of a beverage.

When juice from fruits and/or vegetables is added in this way, a ratio of the ORAC value derived from tealeaf powder to the total ORAC value is preferably equal to or more than 50 percent from viewpoints of flavor, a recommended dietary allowance and costs.

Regarding a formulation of the beverage for efficiently supplementing equal to or more than 5,300 ORAC in a day, it may be designed to be able to supplement equal to or more than 5,300 ORAC by serving either once a day or three times a day with meals. To this end, it is preferable to compound equal to or more than 1,767 ORAC units, which is the third part of 5,300 ORAC, for a serving. Additionally, the ORAC value is preferably equal to or more than 7.4 unit/g in order to ingest equal to or more than 1,767 ORAC in amount of 240 grams (one cup).

Regarding a formulation of the beverage for efficiently supplementing the ORAC necessary for one day through one serving, it is preferable to compound equal to or more than 5,300 ORAC units for one serving. Also, the ORAC value is preferably equal to or more than 22.1 unit/g in order to ingest equal to or more than 5,300 ORAC in amount of 240 grams (one cup).

### EXAMPLE

Beverages according to the present invention were experimentally made and evaluated, which will be explained below.

Prepared were relatively coarse powdery green tea A having caffeine content of 2.9 weight % and median radius of equal to or more than 50 μm, and relatively fine powdery green tea B having caffeine content of 0.1 weight % which was achieved through a decaffeination treatment by means of the carbon dioxide supercritical extraction and median radius of equal to or more than 50 μm.

Fruit beverages and vegetable beverages were prepared with using the powdery green teas A and B. In addition, for comparison, a fruit beverage and a vegetable beverage to which any powdery green tea had not been added at all were also prepared. Each of Tables 5 and 6 shows compositional ratio of these beverages.

TABLE 5

| Name of raw | Comparative | Example 1 | Example |
|---|---|---|---|
| material | example 1 (w/w %) | (w/w %) | 2 (w/w %) |
| Six-fold | 18.0 | 18.0 | 18.0 |
| concentrated | | | |
| grapefruit juice | | | |
| Pectin | 0.3 | 0.3 | 0.3 |
| Flavor | 0.1 | 0.1 | 0.1 |
| Powdery green tea A | — | 1.0 | — |
| Powdery green tea B | — | — | 1.0 |
| Pure water | 81.6 | 80.6 | 80.6 |

TABLE 6

| Name of raw | Comparative | Example 3 | Example 4 |
|---|---|---|---|
| material | example 2 (w/w %) | (w/w %) | (w/w %) |
| Tomato puree | 10.0 | 10.0 | 10.0 |
| Six-fold | 7.0 | 7.0 | 7.0 |
| concentrated carrot | | | |
| juice | | | |
| Six-fold | 3.5 | 3.5 | 3.5 |
| concentrated | | | |
| spinach juice | | | |
| Celery juice | 1.0 | 1.0 | 1.0 |
| Parsley juice | 1.0 | 1.0 | 1.0 |
| Lemon juice | 5.0 | 5.0 | 5.0 |
| Powdery green tea A | — | 0.8 | — |
| Powdery green tea B | — | — | 0.8 |
| Pure water | 72.5 | 71.7 | 71.7 |

Table 7 shows the ORAC values per unit gram and ratios of the ORAC value derived from tealeaf powder to the total ORAC value, with regard to Comparative examples 1, 2 and Examples 1 to 4.

TABLE 7

| | | Ratio of ORAC value |
|---|---|---|
| | | derived from tealeaf |
| | | powder to total ORAC |
| | ORAC value (unit/g) | value (%) |
| Comparative example 1 | 14.2 | 0 |
| Example 1 | 33.2 | 57.2 |
| Example 2 | 32.7 | 56.6 |
| Comparative example 2 | 7.1 | 0 |
| Example 3 | 22.3 | 68.2 |
| Example 4 | 22.1 | 67.9 |

An addition of green leaf powder enables to enhance the ORAL value of Examples 1 and 2 twice or more as large as the value of Comparative examples 1, and the ORAC value of Example 3 and 4 three or more times as large as the value of Comparative example 2. Further, due to influences of the decaffeination treatment, Examples 2, 4 had the values slightly smaller than those of Examples 1, 3.

Table 8 shows a result where caffeine content has been measured.

TABLE 8

| | Caffeine content (mg/100 g) |
|---|---|
| Comparative example 1 | 0.0 |
| Example 1 | 29.0 |
| Comparative example 2 | 1.0 |
| Example 2 | 0.0 |
| Comparative example 3 | 23.1 |
| Comparative example 4 | 0.8 |

With the decaffeination treatment, the caffeine content can be suppressed even when the ORAC value was raised twice or three times with respect to the comparative examples.

Table 9 shows evaluation results of texture. For the evaluation, three panelists performed sensory inspections for Examples 1 to 4.

TABLE 9

| | Panelist A | Panelist B | Panelist C | Average score |
|---|---|---|---|---|
| Example 1 | −3 | −3 | −3 | −3 |
| Example 2 | 0 | 0 | 0 | 0 |
| Example 3 | −2 | −3 | −1 | −2 |
| Example 4 | 0 | +1 | +1 | 0.67 |

Evaluation scales:
extremely difficult to drink: −3,
difficult to drink: −2,
slightly difficult to drink: −1,
normal: 0
slightly easy to drink: +1,
easy to drink: +2,
extremely easy to drink: +3

It was found that the median radius of used powdery tea equal to or less than 50 μm gives better texture. From the comparison of Examples 2 and 4, it is found that smaller additive amount gives a slightly better result.

As obvious from the above explanation, according to the present invention, it is possible to provide the antioxidant agent capable of easily enhancing the intake of ORAC, and the beverage using the agent.

What is claimed is:

1. An antioxidant agent comprising tealeaf as an active ingredient for enhancing Oxygen Radical Absorbance Capacity (hereinafter ORAC).

2. The antioxidant agent according to claim 1, wherein the tealeaf is plucked from tea Camellia sinensis.

3. The antioxidant agent according to claim 1, wherein the tealeaf is decaffeinated.

4. The antioxidant agent according to claim 1, wherein the tealeaf is in a powdery form having a median diameter equal to or less than 50 μm.

5. The antioxidant agent according to claim 1, wherein the antioxidant agent has an ORAC value equal to or more than 950 unit/g.

6. The antioxidant agent according to claim 5, wherein the agent is individually packed per a unit dosage and has an ORAC value equal to or more than 5,300 units per one package.

7. A beverage comprising the antioxidant agent according to any one of claims 1-6.

8. The beverage according to claim 7, wherein juice of fruits and/or vegetables, or a mixture thereof is contained.

9. The beverage according to claim 8, wherein a ratio of the ORAC value derived from tealeaf powder to the total ORAC value is equal to or more than 50%.

10. The beverage according to claim 7, wherein the ORAC value is equal to or more than 7.4 unit/g and equal to or more than 1,767 unit/serving.

11. The beverage according to claim 7, wherein the ORAC value is equal to or more than 22.1 unit/g and equal to or more than 5,300 unit/serving.
